(19) United States
(12) Patent Application Publication
(10) Pub. No.: US 2014/0261984 A1
(43) Pub. Date: Sep. 18, 2014

(54) Z AXIS WINDING FOR FILAMENT WOUND MATERIALS

(71) Applicants: Geoffrey POWERS, Houston, TX (US); Wesley Clint PRITCHETT, Liberty, TX (US); Matthew Richard STAGE, Houston, TX (US)

(72) Inventors: Geoffrey POWERS, Houston, TX (US); Wesley Clint PRITCHETT, Liberty, TX (US); Matthew Richard STAGE, Houston, TX (US)

(21) Appl. No.: 14/209,515

(22) Filed: Mar. 13, 2014

Related U.S. Application Data
(60) Provisional application No. 61/779,664, filed on Mar. 13, 2013.

(51) Int. Cl. B29C 70/16

(52) U.S. Cl. CPC B29C 70/16
USPC 156/184; 156/446; 156/390

(57) ABSTRACT

A rotatable mandrel for use in a filament winding process to form a composite material includes a body having at least one peak and at least one valley on an external surface of the body. The mandrel is rotatable and is configured to receive fibers on the at least one peak and the at least one valley.

### BACKGROUND OF THE INVENTION

1. Field of the Invention

Embodiments of the invention generally relate to a system, method, and apparatus for manufacturing a composite material. More particularly, embodiments of the invention relate to a system, method, and apparatus for manufacturing a composite material using filament winding.

2. Description of the Related Art

Composite materials may be manufactured by using a filament winding technique. The filament winding technique often involves winding fiber filaments over a cylindrical mandrel at varying speeds, tensions, and angles to achieve different mechanical properties. The fibers are coated in resin such that when the winding process is complete, the material may be cured to bond fibers and form a composite material. After curing, the mandrel is removed from the composite material.

Filament wound composite materials often result in uniform layers, and therefore have uniform shear planes, as shown in FIG. 6. Because the shear planes are uniform, the composite materials exhibit relatively low longitudinal axis shear strength. Accordingly, there is a need for a system, method, and apparatus that can produce a composite material with increased longitudinal axis shear strength.

### SUMMARY OF THE INVENTION

In one embodiment, a mandrel is provided for use in a filament winding process to form a composite material. The mandrel may include a body having at least one peak and at least one valley on an external surface of the body, wherein the mandrel is rotatable and is configured to receive fibers on the at least one peak and the at least one valley.

In another embodiment, a system for forming a composite material using a filament winding process includes a resin bath for coating fibers with a resin; a carriage hood for receiving the resin coated fibers and moving the resin coated fibers along a longitudinal axis of a track; and a mandrel having at least one peak and at least one valley on an external surface, wherein the mandrel is configured to rotate relative to the longitudinal axis of the track while receiving the resin coated fibers on the external surface as the carriage hood moves the resin coated fibers along the track.

In another embodiment, a method of forming a composite material includes coating fibers in resin; moving the resin coated fibers along a track; rotating a mandrel relative to the track, wherein the mandrel includes at least one peak and at least one valley on an external surface; disposing the coated fibers onto the external surface of the rotating mandrel as the fibers are moved along the track; and curing the resin coated fibers to form the composite material.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a system for manufacturing composite material using filament winding;

FIG. 2 is a perspective view of a mandrel and tension gears used in the system illustrated in FIG. 1, according to one embodiment of the invention;

FIG. 3 is a side view of the mandrel and tension gears shown in FIG. 2;

FIG. 4A is a cross-sectional view of a mandrel according to one embodiment of the invention;

FIG. 4B is a cross-sectional view of a mandrel according to one embodiment of the invention;

FIG. 4C is a is a cross-sectional view of a mandrel according to one embodiment of the invention;

FIG. 4D is a cross-sectional view of a mandrel according to one embodiment of the invention;

FIG. 4E is a perspective view of a mandrel according to one embodiment of the invention;

FIG. 5 is a side view of a mandrel prior to inflation according to one embodiment of the invention;

FIG. 6 is an illustration of shear planes formed in filament wound composite material using a prior art mandrel;

FIG. 7A is a partial side view of shear planes formed in filament wound composite material using an embodiment of the present invention;

FIG. 7B is a partial perspective view of one layer formed in filament wound composite material using an embodiment of the present invention.

### DETAILED DESCRIPTION

Embodiments of the invention provide for systems, methods, and apparatus for producing composite materials with increased longitudinal axis shear strength.

FIG. 1 is an illustration of a system for manufacturing a composite material using filament winding. Continuous fibers 10, or filaments, such as glass, carbon, or aramid fibers, for example, are fed through a resin bath 15 into a carriage hood 20. The resin bath 15 coats the fibers 10 in resin 17, which may be an epoxy blend. For example, the resin blend may consist of polyurethane or phenolic, or may be a blend of two or more resins. It is contemplated that any fiber 10 or any resin 17 known to one of ordinary skill in the art may be used. Also, while the fiber is typically wet wound, as described, it is contemplated that the fibers could be pre-impregnated and dry wound, or post-impregnated with resin.

Once the fibers 10 reach the carriage hood 20, multiple fibers 10 may be consolidated into a fiber group and then wound around a mandrel 30. The carriage hood 20 and the mandrel 30 are typically positioned parallel to one another. The carriage hood 20 includes a carriage 22 and a track 25, and the carriage 22 moves (or translates) back and forth along a longitudinal axis of the track. As the carriage 22 translates along the track 25, the mandrel 30 rotates about a winding axis 32, oftentimes the central longitudinal axis of the mandrel 30. Accordingly, as the fibers are fed from the carriage hood 20 to the mandrel 30, the carriage hood 20 positions the fibers 10 around the mandrel 30 at various winding angles 34 relative to the winding axis 32 until a desired thickness is satisfied. The winding angle 34 of the carriage hood may be altered by adjusting the speed that the carriage 22 translates along the track 25. The winding angle 34 changes the mechanical properties of the resultant composite material. Typically, each individual layer has a winding angle 34 of about 15 to about 85 degrees with respect to the winding axis 32 of the mandrel 30. In another embodiment, each individual layer has a winding angle 34 of about 30 to about 70 degrees with respect to the winding axis 32 of the mandrel 30.

After the fibers 10 are wound onto the mandrel 30, the fibers 10 and mandrel 30 are placed in an oven and heated to a pre-designated temperature to cure the material. The post cure process cures the resin 17 and bonds the fibers 10 together to form a composite material 40 (shown in FIGS. 6-7). After curing, the composite material is removed from the mandrel 30.

The mandrel 30 used in the filament winding process may be cylindrical in form. Therefore, as the fibers 10 are wound around the cylindrical mandrel 30, the carriage hood 20 positions the fibers 10 at various angles in uniform layers on the mandrel 30, and in parallel to one another, as shown in FIG. 6. The uniform fiber-resin layers in the composite material 40 result in uniform shear planes 45.

In one embodiment, a composite material 40 having non-uniform shear planes that increase the longitudinal axis shear strength is provided. FIG. 2 is a perspective view of a mandrel 130 and tension gears 150A, B used in the system illustrated in FIG. 1, and described above, according to one embodiment of the invention, and FIG. 3 is a side view of the mandrel 130 and tension gears 150A, B as shown in FIG. 2. The mandrel 130 includes an external surface that is non-cylindrical along its longitudinal axis. In one embodiment, and as shown in FIGS. 2 and 3, the external surface of the mandrel 130 may include one or more peak 135 and one or more valley 140 along its longitudinal axis. FIGS. 4A-4D illustrate cross-sectional views of the outer surface of other exemplary embodiments of a mandrel 130A-130D. As shown in FIGS. 4A-4D, the external surface of the mandrel 130A-130D may include one or more peaks 135A-135D and one or more valleys 140A-140 radially positioned around the circumference of the mandrel. In one embodiment, the external surface of the mandrel 130 may include one or more peaks and valleys along both its longitudinal axis and radially around its circumference. FIG. 4E illustrates a perspective view of a mandrel 130E according to one embodiment of the invention. As shown, the external surface of the mandrel 130E may include a helical structure 145 along its longitudinal axis. The cross sections and configurations of the mandrels 130A-130E shown in FIGS. 4A-4E are merely illustrative of the numerous configurations that the mandrel 130 could have, and are not meant to be limiting in any way.

In one embodiment of the invention, the mandrel 130 is inflatable. FIG. 5 is a side view of a mandrel prior to inflation according to one embodiment of the invention. The inflatable mandrel 130 includes an outer wall 160 that may consist of a material that may expand upon inflation. The material may be a rubber or any other expandable durable material known to one of ordinary skill in the art. The inflatable mandrel 130 further includes a recess 164 for filling with a fluid, such as air or water, a first end 166 where the fluid may be injected into the recess 164, and a second end 168 that is closed. The inflatable mandrel 130 may include retention bands 162 that prevent expansion of the mandrel material at certain areas during inflation.

In one embodiment of the invention, the mandrel 130 may be dissolvable or selectively breakable. For example, the mandrel 130 could be made of ceramic, wherein the ceramic may exhibit good strength characteristics, but may be shattered given the right force applied to such mandrel 130.

As discussed with respect to FIG. 1, in one embodiment, the mandrel 130 rotates around a winding axis 132, and the fibers 10 coated in resin 17 are wound around the mandrel 130 as the carriage hood 20 translates along the track 25. The fibers 10 are wound onto a mandrel surface that is non-cylindrical, i.e. the peaks and valleys of the mandrel 130. One or more tension gears 150A, B that include reciprocal outer surfaces to the mandrel 130 are used to position the fibers 10 into the valleys 140 of the mandrel 130. While FIGS. 2 and 3 show two tension gears 150A, B, it is contemplated that any number of tension gears 150 could be used, for example, one, three, or four. The tension gears 150A, B apply a force to the fibers 10 as the fibers 10 are fed onto the mandrel 130 in order to position the fibers 10 along the external surface of the mandrel 130, including all peaks 135 and valleys 140. The force of the tension gears 150A, B may stem from a deformable member, such as a spring, directing the tension gears 150A, B toward the mandrel 130, or may be a result of any other method known to one of ordinary skill in the art.

As the fibers 10 are fed onto the mandrel 130 from the carriage hood 20, as described above, the fibers 10 conform to the external surface of the mandrel 130 at various angles dictated by the winding angle 34 of the carriage hood. Because the mandrel 130 includes one or more peaks 135 and valleys 140, the fiber placement on the mandrel 130 is non-planar. In other words, the fibers 10 along the Z-axis are non-planar. FIG. 7A illustrates a partial side view of shear planes formed in filament wound composite material using an embodiment of the present invention, and FIG. 7B is a partial perspective view of one layer formed in filament wound composite material using an embodiment of the present invention. As shown, the fibers 10 are positioned along the peak 135 and valley 140. The initial layers exhibit more curvature as they are positioned in deeper recesses along the valley 140. However, as the fibers 10 are continuously layered into the valley 140, the layers become more and more shallow as the recess of the valley 140 becomes more shallow. As the fibers 10 continue to stack, the fibers 10 will eventually create a barrier which will prevent the fibers from separating after the winding process is completed. However, because the resultant layers are non-planar, the layers do not present uniform shear planes along the z-axis. The longitudinal axis shear strength of the composite material 40 is significantly increased in comparison to uniform shear planes due to the resultant non-planar layers.

After the fibers 10 are fed onto the mandrel 130 to the desired thickness, the mandrel 130 and fibers 10 are placed in an oven and cured as discussed with respect to FIG. 1. Once again, curing allows the resin 17 and the fibers 10 to bond and form the composite material 40. After curing, the mandrel 130 must be removed from the composite material 40. If the mandrel 130 is inflatable, the mandrel 130 may be deflated and separated from the composite material 40. If the mandrel 130 includes a helical configuration, as shown in FIG. 4E, the mandrel 130 may be rotated away and removed from the composite material 40. If the mandrel 130 is dissolvable or breakable, the mandrel 130 may be dissolved or broken, respectively, and any remainder mandrel material removed from the composite material 40.

Once the mandrel 130 is removed from the composite material 40, the composite material 40 may be formed into a desired shape. For example, the composite material 40 may be machined into a tubular configuration. In one embodiment, the composite material 40 may be formed into a slip used in conjunction with a downhole oil and gas tool. While slips in the oil and gas industry are known to shear along a typically uniform shear plane, a slip made from the composite material 40 described herein exhibits a higher performance due to the non-uniform shear planes of the material 40.

In one embodiment, a mandrel used in a filament winding process to form a composite material includes a body with at least one peak and at least one valley on an external surface of the body. The mandrel is rotatable and accepts fibers on the at least one peak and the at least one valley of the body.

In one embodiment, a system used in a filament winding process for forming a composite material includes a resin bath for coating fibers in resin, a carriage hood for accepting resin coated fibers and moving the resin coated fibers along a longitudinal axis of a track, and a mandrel that includes a longitudinal axis positioned parallel to the track longitudinal axis. The mandrel rotates about the mandrel longitudinal axis and accepts the resin coated fibers along an external surface of the mandrel as the carriage hood moves the resin coated fibers along the track longitudinal axis. The mandrel further includes a body with at least one peak and at least one valley on the external surface of the body.

In another embodiment, a system for forming a composite material using a filament winding process includes a resin bath for coating fibers with a resin; a carriage hood for receiving the resin coated fibers and moving the resin coated fibers along a longitudinal axis of a track; and a mandrel having a longitudinal axis positioned adjacent the track, the mandrel rotatable about the mandrel longitudinal axis to receive the resin coated fibers on an external surface of the mandrel as the carriage hood moves the resin coated fibers along the track, wherein the mandrel further includes at least one peak and at least one valley on the external surface of the mandrel.

In one embodiment, a method of forming a composite material includes coating fibers in resin; moving the resin coated fibers along a track; rotating a mandrel relative to the track, wherein the mandrel includes at least one peak and at least one valley on an external surface; disposing the coated fibers onto the external surface of the rotating mandrel as the fibers are moved along the track; and curing the resin coated fibers to form the composite material.

While the foregoing is directed to embodiments of the invention, other and further embodiments of the invention may be devised without departing from the basic scope thereof, and the scope thereof is determined by the claims that follow.

1. A mandrel for use in a filament winding process to form a composite material, the mandrel comprising:
a body having at least one peak and at least one valley on an external surface of the body, wherein the mandrel is rotatable and is configured to receive fibers on the at least one peak and the at least one valley.

2. The mandrel of claim 1, wherein the at least one peak and the at least one valley are positioned along a longitudinal axis of the mandrel.

3. The mandrel of claim 1, wherein the at least one peak and the at least one valley are radially positioned around an external circumference of the mandrel.

4. The mandrel of claim 1, wherein the at least one peak and the at least one valley are positioned along a longitudinal axis of the mandrel and radially around an external circumference of the mandrel.

5. The mandrel of claim 1, wherein the mandrel is inflatable.

6. The mandrel of claim 1, wherein the mandrel is ceramic.

7. The mandrel of claim 1, wherein the mandrel is dissolvable.

8. The mandrel of claim 1, wherein the external surface of the mandrel is helical along a longitudinal axis of the mandrel.

9. A system for forming a composite material using a filament winding process, comprising:
a resin bath for coating fibers with a resin;
a carriage hood for receiving the resin coated fibers and moving the resin coated fibers along a longitudinal axis of a track; and
a mandrel having at least one peak and at least one valley on an external surface, wherein the mandrel is configured to rotate relative to the longitudinal axis of the track while receiving the resin coated fibers on the external surface as the carriage hood moves the resin coated fibers along the track.

10. The system of claim 9, further comprising at least one tension gear having a tension gear external surface that is reciprocal to the mandrel external surface, the tension gear directing the coated fibers into the at least one valley of the mandrel.

11. The system of claim 9, further comprising an oven for curing the resin coated fibers after placement of the fibers along the external surface of the mandrel.

12. The system of claim 9, wherein the at least one peak and the at least one valley are positioned along the mandrel longitudinal axis.

13. The system of claim 9, wherein the at least one peak and the at least one valley are radially positioned around an external circumference of the mandrel.

14. The system of claim 9, wherein the at least one peak and the at least one valley are positioned along the mandrel longitudinal axis of the mandrel and radially around an external circumference of the mandrel.

15. The system of claim 9, wherein the mandrel is inflatable.

16. A method of forming a composite material, comprising:
coating fibers in resin;
moving the resin coated fibers along a track;
rotating a mandrel relative to the track, wherein the mandrel includes at least one peak and at least one valley on an external surface;
disposing the coated fibers onto the external surface of the rotating mandrel as the fibers are moved along the track; and
curing the resin coated fibers to form the composite material.

17. The method of claim 16, further comprising moving a tension gear towards the mandrel external surface, the tension gear including a tension gear external surface that is reciprocal to the mandrel external surface.

18. The method of claim 16, further comprising ceasing rotation of the mandrel once the resin coated fibers reach a pre-determined thickness on the mandrel.

19. The method of claim 16, further comprising moving the mandrel away from the composite material.

20. The method of claim 16, wherein the at least one peak and the at least one valley are positioned along the mandrel longitudinal axis.

21. The method of claim 16, wherein the at least one peak and the at least one valley are radially positioned around an external circumference of the mandrel.

22. The method of claim 16, further comprising positioning a longitudinal axis of the mandrel parallel to the track.
